(19) United States
(12) Patent Application Publication
(10) Pub. No.: US 2025/0327651 A1
(43) Pub. Date: Oct. 23, 2025

(54) COMPENSATION VALUE OF TOUCH TRIGGER PROBE INSPECTION SYSTEM AND COMPENSATION VALUE OF TOUCH TRIGGER PROBE INSPECTION METHOD

(71) Applicant: OKUMA CORPORATION, Niwa-Gun (JP)

(72) Inventor: Yuji MIZOGUCHI, Niwa-Gun (JP)

(73) Assignee: OKUMA CORPORATION, Niwa-Gun (JP)

(21) Appl. No.: 19/172,721

(22) Filed: Apr. 8, 2025

(30) Foreign Application Priority Data
Apr. 23, 2024 (JP) 2024-069957

(51) Int. Cl. G01B 5/012

(52) U.S. Cl. CPC G01B 5/012

(57) ABSTRACT

A compensation value of a touch trigger probe inspection system includes an initial offset value estimating unit, an offset value-during-inspection estimating unit, and a compensation value error estimating unit. The offset value-during-inspection estimating unit calculates a value of an offset-displacement-amount-during-inspection based on an inspection-measurement-result-before-inversion and an inspection-measurement-result-after-inversion. The inspection-measurement-result-before-inversion is obtained by measuring a measurement object during inspection at the first reference measurement angle. The inspection-measurement-result-after-inversion is obtained by measuring the measurement object during inspection at the measurement angle varied by 180° from the first reference measurement angle. The compensation value error estimating unit estimates an error of a compensation value of the touch trigger probe based on the initial value of the offset displacement amount and the value of the offset-displacement-amount-during-inspection.

### CROSS REFERENCE TO RELATED APPLICATION

This application claims the benefit of Japanese Patent Application Number 2024-069957 filed on Apr. 23, 2024, the entirety of which is incorporated by reference.

### FIELD OF THE INVENTION

The disclosure relates to a compensation value inspection system and a compensation value inspection method for inspecting a compensation value of a touch trigger probe used for, such as the measurement of a workpiece origin position.

### BACKGROUND OF THE INVENTION

Conventionally, a touch trigger probe is brought into contact with the workpiece or a reference ball while is indexed to a plurality of rotation angles when, for example, the origin position of the workpiece is measured, the workpiece dimensions after machining are measured, and machine accuracy is calibrated. In addition, for the touch trigger probe, a compensation value is set to compensate a deviation for the distance from the reference point of the main spindle to a measurement point, such as the radius of a stylus ball or the length of the touch trigger probe. However, if the touch trigger probe changes over time, for example, thermal distortion of the touch trigger probe occurs due to the influence of temperature change in the usage environment, a deviation is generated between the set compensation value and the actual error, and the deviation becomes a measurement error.

As a method to avoid the measurement error caused by the temporal change of a touch trigger probe as described above, there is a method for performing calibration work to periodically reset the compensation value. For example, JP 2016-083729 A discloses a method for calibrating a compensation value in a radial direction of a touch trigger probe distal end portion by measuring a reference ball that serves as a calibration reference using the touch trigger probe.

As another method to avoid the measurement error caused by the temporal change of a touch trigger probe, there is a method for canceling the influence of a measurement error by devising a measurement method. For example, JP 2020-196051 A discloses a method for canceling the influence of a measurement error in a radial direction of a touch trigger probe distal end portion by changing an indexing angle of a main spindle to which a touch trigger probe is mounted according to a measurement target. Specifically, when the coordinates of a predetermined measurement point are measured, the main spindle is inverted to measure the coordinates twice, and the measurement results before and after the inversion are averaged to cancel the influence of a measurement error.

However, with the method disclosed in JP 2016-083729 A, there is a issue with the calibration work of the touch trigger probe tending to be performed more than necessary, making the calibration work burdensome. In addition, when a calibration reference is always installed inside a machine tool, a issue with the space for installing a workpiece becoming narrow and a issue with the calibration accuracy deteriorating due to the influence of chips and cutting fluids are caused. Accordingly, it may be difficult to always install the calibration reference inside the machine tool. Therefore, it is conceivable that by configuring the calibration reference to be removably attachable, the calibration reference is installed each time the calibration work is performed. However, if the calibration reference is attached and detached each time the calibration work is performed, a issue arises that the burden on an operator increases depending on the implementation frequency of the calibration work.

On the other hand, the method disclosed in JP 2020-196051 A can reduce the implementation frequency of the calibration work of the touch trigger probe. However, it is necessary to perform the coordinate measurement of a predetermined measurement point twice, namely, before and after the inversion of the main spindle each time, therefore causing a issue with the coordinate measurement taking time.

Therefore, the disclosure is made in view of the above-described issues, and it is an object of the disclosure to provide a compensation value inspection system and a compensation value inspection method for a touch trigger probe that can simply inspect a compensation value of a touch trigger probe, in order to suppress the implementation frequency of work related to calibration for resetting the compensation value of the touch trigger probe to a minimum and ensure the measurement accuracy of a position by the touch trigger probe at anytime.

### SUMMARY OF THE INVENTION

In order to achieve the above-described objective, the disclosure according to a first aspect provides a compensation value of a touch trigger probe inspection system that inspects an error of a compensation value of a touch trigger probe mounted to a main spindle in a machine tool. The machine tool has translational axes of three or more axes and the main spindle rotatable with a tool mounted thereon. When an angle between an indexing direction of the main spindle to which the touch trigger probe is mounted and a contact direction is set a measurement angle. The contact direction is a direction in which the touch trigger probe is brought into contact with a predetermined measurement object by movement of the main spindle on a plane perpendicular to an axis line of the main spindle. Also, the measurement object is measurable with the touch trigger probe at a plurality of the measurement angles. Further, a predetermined measurement angle is set as a first reference measurement angle. The compensation value of the touch trigger probe inspection system includes an initial offset value estimating unit, an offset value-during-inspection estimating unit, and a compensation value error estimating unit. The initial offset value estimating unit calculates an initial value of an offset displacement amount as a deviation of a center position of a stylus ball of the touch trigger probe with respect to a center of the main spindle, based on an initial-measurement-result-before-inversion and an initial-measurement-result-after-inversion. The initial-measurement-result-before-inversion is obtained by measuring an initial measurement object at the first reference measurement angle. The initial-measurement-result-after-inversion is obtained by measuring the initial measurement object at a measurement angle varied by 180° from the first reference measurement angle. Further, the offset value-during-inspection estimating unit calculates a value of the offset-displacement-amount-during-inspection based on an inspection-measurement-result-before-inversion and an inspection-measurement-result-after-inversion. The inspection-measurement-result-before-inversion is obtained by measuring a measurement object during inspection at the first reference measurement angle. The inspection-measurement-result-after-inversion is obtained by measuring the measurement object during inspection at the measurement angle varied by 180° from the first reference measurement angle. Further, the compensation value error estimating unit estimates an error of a compensation value of the touch trigger probe based on the initial value of the offset displacement amount and the value of the offset-displacement-amount-during-inspection.

The disclosure according to a second aspect, which is in the disclosure according to the first aspect, the initial offset value estimating unit obtains the initial-measurement-result-after-inversion by varying the indexing direction of the main spindle by 180° while the contact direction for obtaining the initial-measurement-result-before-inversion unchanged.

The disclosure according to a third aspect, which is in the disclosure according to the first aspect, the initial measurement object is a ring-shaped, spherical, or cylindrical calibration reference, and the initial offset value estimating unit obtains the initial-measurement-result-after-inversion by varying the contact direction by 180° while the indexing direction of the main spindle for obtaining the initial-measurement-result-before-inversion unchanged.

The disclosure according to a fourth aspect, which is in the disclosure according to any one of the first to third aspects, a measurement angle perpendicular to the first reference measurement angle is set as a second reference measurement angle, the initial offset value estimating unit calculates the initial value of the offset displacement amount based on a measurement result at the second reference measurement angle and a measurement angle varied by 180° from the second reference measurement angle. The offset value-during-inspection estimating unit calculates the value of the offset-displacement-amount-during-inspection based on a measurement result at the second reference measurement angle and the measurement angle varied by 180° from the second reference measurement angle.

In order to achieve the above-described objective, the disclosure according to a fifth aspect provides a compensation value inspection method to inspect an error of a compensation value of a touch trigger probe in a machine tool. The machine tool having translational axes of three or more axes and a main spindle rotatable with a tool mounted thereon. When an angle between an indexing direction of the main spindle to which the touch trigger probe is mounted and a contact direction is set as a measurement angle. The contact direction is a direction in which the touch trigger probe is brought into contact with a predetermined measurement object by movement of the main spindle on a plane perpendicular to an axis line of the main spindle. Also, the measurement object is measurable with the touch trigger probe at a plurality of the measurement angles. Further, a predetermined measurement angle is set as a first reference measurement angle. The compensation value of the touch trigger probe inspection method includes: calculating an initial value of an offset displacement amount as a deviation of a center position of a stylus ball of the touch trigger probe with respect to a center of the main spindle, based on an initial-measurement-result-before-inversion and an initial-measurement-result-after-inversion, the initial-measurement-result-before-inversion being obtained by measuring an initial measurement object at a first reference measurement angle, the initial-measurement-result-after-inversion being obtained by measuring the initial measurement object at a measurement angle varied by 180° from the first reference measurement angle; calculating a value of the offset-displacement-amount-during-inspection based on an inspection-measurement-result-before-inversion and an inspection-measurement-result-after-inversion, the inspection-measurement-result-before-inversion being obtained by measuring a measurement object during inspection at the first reference measurement angle, the inspection-measurement-result-after-inversion being obtained by measuring the measurement object during inspection at the measurement angle varied by 180° from the first reference measurement angle; and estimating an error of a compensation value of the touch trigger probe based on the initial value of the offset displacement amount and the value of the offset-displacement-amount-during-inspection.

According to the disclosure, the initial value of the offset displacement amount is calculated based on the initial-measurement-result-before-inversion and the initial-measurement-result-after-inversion. In addition, the value of the offset-displacement-amount-during-inspection is calculated based on the inspection-measurement-result-before-inversion and the inspection-measurement-result-after-inversion. Furthermore, an error of a compensation value of the touch trigger probe is estimated based on the initial value of the offset displacement amount and the value of the offset-displacement-amount-during-inspection. Therefore, the calibration of the touch trigger probe can be performed only when necessary according to the estimation result of the error of the compensation value of the touch trigger probe. Thus, the implementation frequency of the calibration work of the touch trigger probe can be minimized without impairing accuracy.

Moreover, it is not required to set up a calibration reference at every inspection. Also, an operation that required to vary the measurement angle by 180° from the first reference measurement angle, such as inversion of the main spindle, is performed only once. Therefore, the inspection can be performed in a short time.

### BRIEF DESCRIPTION OF THE DRAWINGS

FIG. 1 is an explanatory perspective view illustrating a machine tool.

FIG. 2 is a block diagram illustrating a configuration related to compensation value inspection for a touch trigger probe in an NC unit.

FIGS. 3A and 3B are explanatory views illustrating the touch trigger probe in a state where offset displacement occurs due to the inclination of a stylus. FIG. 3A illustrates the state from the top, and FIG. 3B illustrates the state from a side.

FIGS. 4A to 4C are explanatory views of an initial measurement object and a stylus ball of the touch trigger probe viewed from the top when an initial value of an offset displacement amount is calculated.

FIG. 5 is an explanatory view of a reference ball and the stylus ball of the touch trigger probe viewed from the top when the initial value of the offset displacement amount is calculated.

FIGS. 6A to 6C are explanatory views of a measurement object during inspection and the stylus ball of the touch trigger probe viewed from the top when a value of the offset-displacement-amount-during-inspection is calculated.

FIG. 7 is a flowchart illustrating a process related to the compensation value inspection for the touch trigger probe.

### DETAILED DESCRIPTION OF THE INVENTION

The following describes in detail a compensation value inspection system and a compensation value inspection method for a touch trigger probe as one embodiment according to the disclosure based on the drawings.

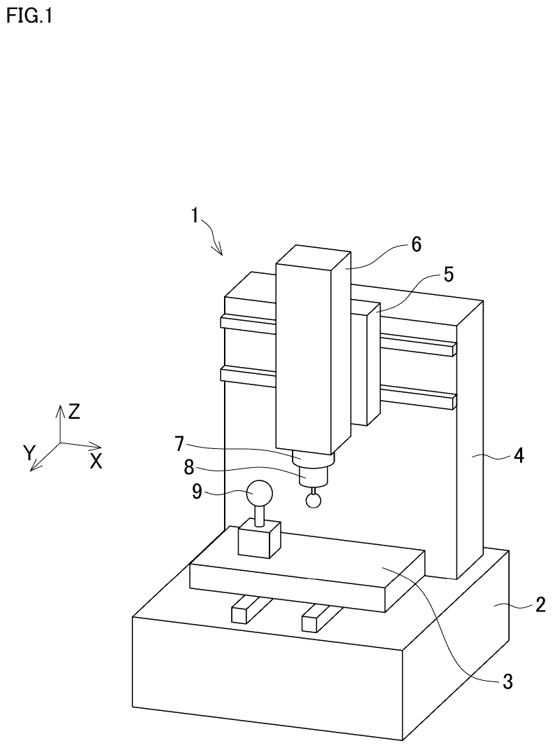

First, a machine tool 1 is described based on FIG. 1. FIG. 1 is an explanatory perspective view illustrating the machine tool 1. The X-axis, Y-axis, and Z-axis in FIG. 1 are three orthogonal axes, namely, translational axes provided in the machine tool 1. The Y-axis direction is a front-rear direction of the machine tool 1, the X-axis direction is a left-right direction, and the Z-axis direction is an up-down direction.

The machine tool 1 is a three-axis machining center. A Y-axis guide is formed on an upper surface of a bed 2. On the Y-axis guide, a table 3 is disposed movably in the Y-axis direction. That is, the table 3 is movable with respect to the bed 2 with one degree of freedom for translation. In addition, a column 4 is disposed upright on a rear portion of the bed 2, and an X-axis guide is formed on a front face of the column 4. On the X-axis guide, a main spindle head 6 is installed via a saddle 5, and the main spindle head 6 is movable in the X-axis direction and Z-axis direction. That is, the main spindle head 6 is movable with respect to the bed 2 with two degrees of freedom for translation, and by combination of the movement of the table 3, the main spindle head 6 is movable with respect to the bed 2 with three degrees of freedom for translation.

Further, the machine tool 1 includes an NC unit 10 to control the operations of a main spindle 7 and each translational axis. The NC unit 10 is configured to include a CPU and a memory connected to the CPU. In the machine tool 1, for example, under the control by the NC unit 10 in response to an operation program stored in the NC unit 10 or an operator's button operation, a tool (not illustrated) mounted on the main spindle 7 of the main spindle head 6 is rotated. Then, the NC unit 10 controls a relative position and a relative posture between the workpiece (not illustrated) secured on the table 3 and the tool, thereby the workpiece is machined.

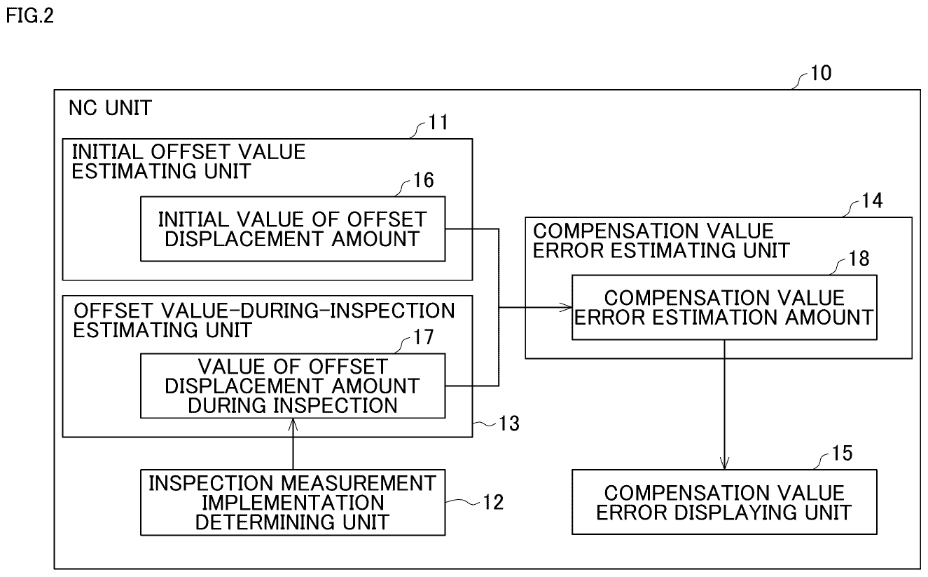

The following describes a compensation value of a touch trigger probe 8 inspection system and a compensation value of a touch trigger probe 8 inspection method as the main part of the disclosure. FIG. 2 is a block diagram illustrating a configuration related to a compensation value inspection for the touch trigger probe 8 in the NC unit 10.

The main spindle 7 can be mounted the touch trigger probe 8 used for calibration work described later. In addition, the table 3 can be installed a reference ball 9 which is a calibration reference for calibrating the touch trigger probe 8. Meanwhile, the NC unit 10 includes an initial offset value estimating unit 11, an inspection measurement implementation determining unit 12, an offset value-during-inspection estimating unit 13, a compensation value error estimating unit 14, and a compensation value error displaying unit 15. The estimating units and the determining units are provided in the NC unit 10 as memories for storing information, such as an operation commands of the machine tool 1, programs to calculate measured values and calculation results.

In the initial offset value estimating unit 11, first, a side face of an initial measurement object is measured by the touch trigger probe 8 mounted to the main spindle 7 according to a measurement procedure described later. The initial measurement object is, for example, a side face of the reference ball 9 installed on the table 3 or a side face of the table 3. Next, a calculation is performed based on the measurement result, and an initial value 16 of an offset displacement amount is calculated and set. The initial value 16 of the offset displacement amount is normally set when the touch trigger probe 8 is calibrated.

In the offset value-during-inspection estimating unit 13, first, a side face of a measurement object during inspection is measured by the touch trigger probe 8 mounted to the main spindle 7 according to a measurement procedure described later. The measurement object during inspection is, for example, a side face of the reference ball 9 installed on the table 3 or a side face of the table 3. Next, a calculation is performed based on the measurement result, and a value 17 of the offset-displacement-amount-during-inspection is calculated and set.

In the compensation value error estimating unit 14, a compensation value error estimation amount 18 is calculated based on the initial value 16 of the offset displacement amount and the value 17 of the offset-displacement-amount-during-inspection.

Here, the types of errors assumed for the measurement in a radial direction with the touch trigger probe 8 are described. Three types of errors are assumed in the disclosure.

A first error is a positioning error of a feed axis of a machine tool. The positioning error of the machine tool is represented by a reference numeral Eₘ. In the feed axis of the machine tool, due to the backlash of a ball screw, even when the feed axis is positioned at the same position, the error may occur between when the feed axis is positioned from the + (plus) side to the − (minus) side and when the feed axis is positioned from the − side to the + side. The error changes when the feed axis is worn out by using the machine tool for a long time. On the other hand, the change of the error can be considered small in a period of use of several days to several weeks.

A second error is an error caused by a signal output characteristic of a touch trigger probe. The error caused by the signal output characteristic is represented by a reference numeral Eₚ. Specifically, the error is an error caused by the delay between when a stylus of the touch trigger probe comes in contact with a measurement object and when it outputs a contact signal or an error caused by characteristics of a contact pair disposed inside the touch trigger probe to detect the contact. In other cases, the error is an error caused by the characteristics of the contact pair may vary depending on the direction of contact with the measurement object. The error caused by the signal output characteristic of the touch trigger probe is less likely to change over time than an error caused by the bending of the stylus of the touch trigger probe described later. However, when the touch trigger probe used is replaced or when the touch trigger probe deteriorates over time due to factors, such as wear of the internal structure of the touch trigger probe, the error significantly changes. On the other hand, when the same touch trigger probe is continuously used for several days to several weeks, the change is considered small.

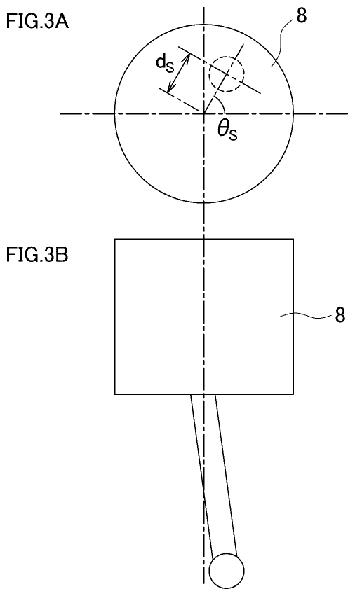

A third error is an error caused by the offset displacement of the stylus ball center of the touch trigger probe with respect to the main spindle center. Specifically, the error is an error caused by the bending of the stylus of the touch trigger probe. The error caused by the offset displacement is presented by a reference numeral Eₛ. The error caused by the offset displacement is caused by factors, such as the thermal distortion and the force applied at the contact with the measurement object. Therefore, the error has a property that it can change with the temperature change of the usage environment and the increase in the number of contacts with the measurement object. FIGS. 3A and 3B illustrate the touch trigger probe 8 in a state where the offset displacement occurs due to the inclination of the stylus. FIG. 3A illustrates the state from the top, and FIG. 3B illustrates the state from a side. Then, the error Eₛ caused by the offset displacement described above can be expressed by the following formula (1), using an angle θₛ and a distance dₛ of the stylus ball center position with respect to the main spindle center.

$${E}_{s , θ} = {d}_{s} cos ( {θ}_{s} - θ ) \qquad Formula ( 1 )$$

θ: Angle in a contact direction of the touch trigger probe with respect to a main spindle indexing direction
E_{s,θ}: Error in the radial direction in the contact direction e
θₛ: Angle of the stylus ball center position with respect to the main spindle center
dₛ: Distance to the stylus ball center position with respect to the main spindle center

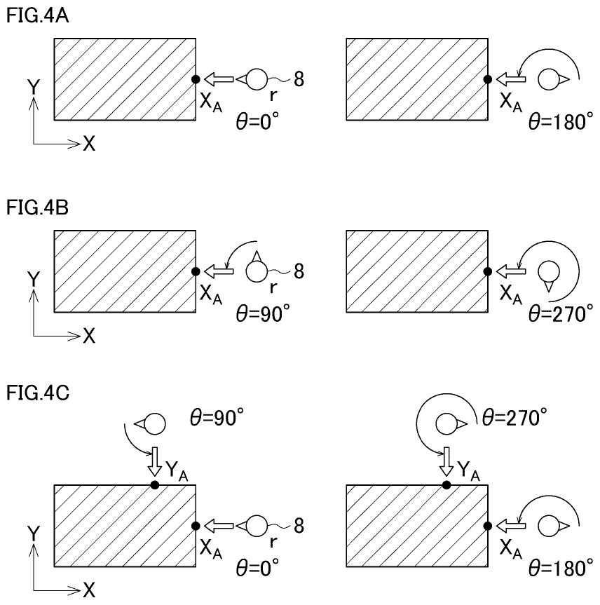

A first method to calculate the initial value 16 of the offset displacement amount by the initial offset value estimating unit 11 is described based on FIGS. 4A to 4C. FIGS. 4A to 4C are explanatory views of an initial measurement object and the stylus ball of the touch trigger probe 8 viewed from the top when the initial value 16 of the offset displacement amount is calculated. In FIGS. 4A to 4C, a hatched part, a black circle, and a small circle represent the initial measurement object, a measurement point, and the stylus ball having a radius r, respectively. In addition, a white triangle attached to the stylus ball represents the indexing direction of the main spindle 7 to which the touch trigger probe 8 is mounted. Further, a white arrow represents the contact direction in which the stylus ball, namely, touch trigger probe is brought into contact with the initial measurement object. Furthermore, an angle between the indexing direction and the contact direction is defined as a measurement angle θ.

In the first method, as illustrated in FIGS. 4A to 4B, the measurement is performed while the indexing direction of the main spindle 7 to which the touch trigger probe 8 is mounted is changed. Then, the initial value 16 of the offset displacement amount is calculated from the measurement results. Specifically, in the initial offset value estimating unit 11, a predetermined measurement angle is set as a reference measurement angle. Subsequently, a predetermined measurement point of the initial measurement object is measured at two measurement angles, namely, the reference measurement angle and a measurement angle inverted 180° with respect to the reference measurement angle. For example, as illustrated in FIG. 4A, a first reference measurement angle is set to 0°. Then, a measurement point X_{A} on a measurement surface of the initial measurement object is measured at 0° and 180°. At this time, an initial-measurement-result-before-inversion Â₁, which is the measurement result at 0°, can be expressed by the following formula (2). On the other hand, an initial-measurement-result-after-inversion Â₁′, which is the measurement result at 180°, can be expressed by the following formula (3).

$${\hat{A}}_{1} = {x}_{A} + r + {\hat{E}}_{m , x +} + {\hat{E}}_{p , θ = 0} + {\hat{E}}_{s , θ = 0} \qquad Formula ( 2 )$$

$${\hat{A}}_{1} = {x}_{A} + r + {\hat{E}}_{m , x +} + {\hat{E}}_{p , θ = 0} + {\hat{d}}_{s} cos {\hat{θ}}_{s}$$

$${{\hat{A}}_{1}}^{′} = {x}_{A} + r + {\hat{E}}_{m , x +} + {\hat{E}}_{p , θ = 180} + {\hat{E}}_{s , θ = 180} \qquad Formula ( 3 )$$

$${{\hat{A}}_{1}}^{′} = {x}_{A} + r + {\hat{E}}_{m , x +} + {\hat{E}}_{p , θ = 180} - {\hat{d}}_{s} cos {\hat{θ}}_{s}$$

Â₁: Initial-measurement-result-before-inversion with respect to the first reference measurement angle
Â₁′: Initial-measurement-result-after-inversion with respect to the first reference measurement angle
θ: Measurement angle
x_{A}: True X-coordinate of the measurement point X_{A} in the initial measurement
r: Radius of the stylus ball
Ê_{m,x+}: Initial value of the positioning error on the X-axis + side of the machine tool
Ê_{p,θ}: Initial value of the error caused by the characteristic of the touch trigger probe
Ê_{s,θ}: Initial value of the error caused by stylus bending
\hat{θ}ₛ: Initial value of the angle of the stylus ball center position with respect to the main spindle center
\hat{d}ₛ: Initial value of the distance to the stylus ball center position with respect to the main spindle center

The initial value 16 (Ê₁) of the offset displacement amount with respect to the first reference measurement angle, which is the initial value 16 (Ê₁) of the offset displacement amount in the X-axis direction here, is calculated by dividing the difference between the initial-measurement-result-before-inversion Â₁ and the initial-measurement-result-after-inversion Â₁′ by two, as shown in the following formula (4).

$${\hat{E}}_{1} = \frac{{\hat{A}}_{1} - {{\hat{A}}_{1}}^{′}}{2} = \frac{{\hat{E}}_{p , θ = 0} - {\hat{E}}_{p , θ = 180}}{2} + {\hat{d}}_{s} cos {\hat{θ}}_{s} \qquad Formula ( 4 )$$

Ê₁: Initial value of the offset displacement amount with respect to the first reference measurement angle

In addition, a measurement angle perpendicular to the first reference measurement angle is set as a second reference measurement angle. In the example illustrated in FIGS. 4A to 4B, since the first reference measurement angle is 0° in FIG. 4A, the second reference measurement angle is 90° as illustrated in FIG. 4B. Accordingly, this time, the measurement point X_{A} on the measurement surface of the initial measurement object is measured at 90° and 270°. At this time, an initial-measurement-result-before-inversion Â₂, which is the measurement result at 90°, can be calculated in the same manner as the initial-measurement-result-before-inversion Â₁. On the other hand, an initial-measurement-result-after-inversion Â₂, which is the measurement result at 270°, can be calculated in the same manner as the initial-measurement-result-after-inversion Â₁. Thus, the initial value 16 (Ê₂) of the offset displacement amount with respect to the second reference measurement angle, which is the initial value 16 (Ê₂) of the offset displacement amount in the Y-axis direction here, is calculated by dividing the difference between the initial-measurement-result-before-inversion Â₂ and the initial-measurement-result-after-inversion Â₂′ by two, as shown in the following formula (5).

$${\hat{E}}_{2} = \frac{{\hat{A}}_{2} - {{\hat{A}}_{2}}^{′}}{2} = \frac{{\hat{E}}_{p , θ = 90} - {\hat{E}}_{p , θ = 270}}{2} - {\hat{d}}_{s} sin {\hat{θ}}_{s} \qquad Formula ( 5 )$$

Â₂: Initial-measurement-result-before-inversion with respect to the second reference measurement angle
Â₂′: Initial-measurement-result-after-inversion with respect to the second reference measurement angle
Ê₂: Initial value of the offset displacement amount with respect to the second reference measurement angle

This is the first method to calculate the initial value 16 of the offset displacement amount.

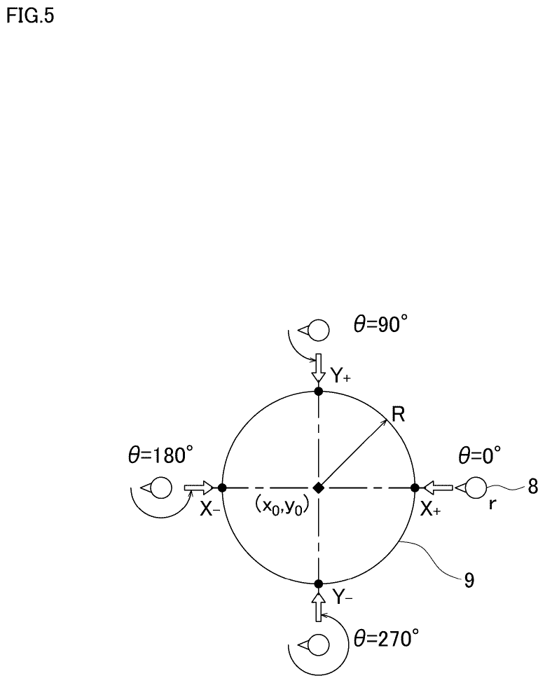

Next, a second method to calculate the initial value 16 of the offset displacement amount by the initial offset value estimating unit 11 is described based on FIG. 5. FIG. 5 is an explanatory view of the reference ball 9, which is an initial measurement object when the initial value 16 of the offset displacement amount is calculated, and the stylus ball of the touch trigger probe 8 viewed from the top. The large circle at the center of FIG. 5, a black circle, and a small circle represent the reference ball 9 having a radius R, a measurement point, and the stylus ball having a radius r, respectively. In addition, a white triangle attached to the stylus ball represents the indexing direction of the main spindle 7 to which the touch trigger probe 8 is mounted. Further, a white arrow represents the contact direction in which the stylus ball, namely, touch trigger probe is brought into contact with the reference ball 9.

In the second method, for example, as illustrated in FIG. 5, a diameter compensation value of the touch trigger probe 8 is obtained using the reference ball 9. The reference ball 9 is one example of a calibration reference. The initial value 16 of the offset displacement amount is calculated based on the diameter compensation value.

In order to obtain the diameter compensation value of the touch trigger probe 8 using the reference ball 9, measurements are performed at measurement points of X₊, Y₊, X₋, and Y₋ on the reference ball 9. Here, in the reference ball 9, measurements at measurement points of X₊, Y₊, X₋, and Y₋ are correspond to those at measurement angles of 0°, 90°, 180°, and 270°, respectively, as illustrated in FIG. 5. That is, in the second method, measurements at measurement points of X₊, Y₊, X₋, and Y₋ on the reference ball 9 can be said to be measurements at same measurement angles as in the first method. Specifically, the measurements at the first reference measurement angle and a measurement angle inverted 180° with respect to the first reference measurement angle in the first method correspond to the measurements at measurement points of X₊ and X₋ in the second method. On the other hand, the measurements at the second reference measurement angle and a measurement angle inverted 180° with respect to the second reference measurement angle in the first method correspond to the measurements at measurement points of Y₊ and Y₋ in the second method.

Therefore, in the case of that the first reference measurement angle is set to 0° and the measurement is performed at 0° and 180° is considered. The coordinates X₊, X₋ obtained by measuring the X₊ side apex of the reference ball 9 at θ=0° and the X₋ side apex of the reference ball 9 at θ=180° are expressed by the following formulas (6) and (7), respectively.

$${X}_{+} = {x}_{0} + R + r + {\hat{E}}_{m , x +} + {\hat{E}}_{p , θ = 0} + {\hat{E}}_{s , θ = 0} \qquad Formula ( 6 )$$

$${X}_{-} = {x}_{0} - R - r + {\hat{E}}_{m , x -} - {\hat{E}}_{p , θ = 180} - {\hat{E}}_{s , θ = 180} \qquad Formula ( 7 )$$

X₊: Measurement result of the X₊ side apex
X₋: Measurement result of the X₋ side apex
x₀: X-coordinate of the center of the reference ball
R: Radius of the reference ball
Ê_{m,x+}: Initial value of the positioning error on the X-axis + side of the machine tool
Ê_{m,x-}: Initial value of the positioning error on the X₋ axis − side of the machine tool

A X-coordinate x₀ of the center of the reference ball 9 is taken as being obtained in advance using known means of measurement. Similarly, the radius R of the reference ball 9 is also taken as being already known. At this time, the diameter compensation value Cₓ₊ of the touch trigger probe 8 when measuring the X₊ side face and the diameter compensation value Cₓ₋ of the touch trigger probe 8 when measuring the X₋ side face are obtained as expressed by the following formulas (8) and (9).

$${C}_{x +} = {X}_{+} - ( {x}_{0} + R ) = + r + {\hat{E}}_{m , x +} + {\hat{E}}_{p , θ = 0} + {\hat{E}}_{s , θ = 0} \qquad Formula ( 8 )$$

$${C}_{x +} = + r + {\hat{E}}_{m , x +} + {\hat{E}}_{p , θ = 0} + {\hat{d}}_{s} cos {\hat{θ}}_{s}$$

$${C}_{x -} = {X}_{-} - ( {x}_{0} - R ) = - r + {\hat{E}}_{m , x -} - {\hat{E}}_{p , θ = 180} - {\hat{E}}_{s , θ = 180} \qquad Formula ( 9 )$$

$${C}_{x -} = - r + {\hat{E}}_{m , x -} - {\hat{E}}_{p , θ = 180} + {\hat{d}}_{s} cos {\hat{θ}}_{s}$$

Cₓ₊: Diameter compensation value of the touch trigger probe when measuring the X₊ side face
Cₓ₋: Diameter compensation value of the touch trigger probe when measuring the X₋ side face
Ê_{m,x+}: Initial value of the positioning error on the X-axis + side of the machine tool
Ê_{m,x-}: Initial value of the positioning error on the X-axis − side of the machine tool

Furthermore, the sum of the diameter compensation value Cₓ₊ of the touch trigger probe 8 when measuring the X₊ side face and the diameter compensation value Cₓ₋ of the touch trigger probe 8 when measuring X₋ side face being divided by two is expressed by the following formula (10).

$$\frac{{C}_{x +} + {C}_{x -}}{2} = \frac{{\hat{E}}_{m , x +} + {\hat{E}}_{m , x -}}{2} + \frac{{\hat{E}}_{p , θ = 0} - {\hat{E}}_{p , θ = 180}}{2} + {\hat{d}}_{s} cos {\hat{θ}}_{s} \qquad Formula ( 10 )$$

Similarly, the diameter compensation value C_{y+} of the touch trigger probe 8 when measuring the Y₊ side face and the diameter compensation value C_{y-} of the touch trigger probe 8 when measuring the Y₋ side face, which are the compensation values in the Y-axis direction, are obtained as expressed by the following formulas (11) and (12).

$${C}_{y +} = + r + {\hat{E}}_{m , y +} + {\hat{E}}_{p , θ = 90} - {\hat{d}}_{s} sin {\hat{θ}}_{s} \qquad Formula ( 11 )$$

$${C}_{y -} = - r + {\hat{E}}_{m , y -} - {\hat{E}}_{p , θ = 270} - {\hat{d}}_{s} sin {\hat{θ}}_{s} \qquad Formula ( 12 )$$

C_{y+}: Diameter compensation value of the touch trigger probe when measuring the Y₊ side face
C_{y-}: Diameter compensation value of the touch trigger probe when measuring the Y₋ side face
Ê_{m,y+}: Initial value of the positioning error on the Y-axis + side of the machine tool
Ê_{m,y-}: Initial value of the positioning error on the Y-axis − side of the machine tool

Subsequently, the sum of the diameter compensation value C_{y+} of the touch trigger probe 8 when measuring the Y₊ side face and the diameter compensation value C_{y+} of the touch trigger probe 8 when measuring the Y₋ side face being divided by two is expressed by the following formula (13).

$$\frac{{C}_{y +} + {C}_{y -}}{2} = \frac{{\hat{E}}_{m , y +} + {\hat{E}}_{m , y -}}{2} + \frac{{\hat{E}}_{p , θ = 90} - {\hat{E}}_{p , θ = 270}}{2} - {\hat{d}}_{s} sin {\hat{θ}}_{s} \qquad Formula ( 13 )$$

Here, the first terms on the right sides of the formula (10) is the sum of the initial value Ê_{m,x+} of the positioning error on the X-axis + side of the machine tool 1 and the initial value Ê_{m,x-} of the positioning error on the X-axis − side of the machine tool 1. Similarly, the first terms on the right sides of the formula (13) are the sum of the initial value Ê_{m,y+} of the positioning error on the Y-axis + side of the machine tool 1 and the initial value Ê_{m,y-} of the positioning error on the Y-axis side of the machine tool 1. As described above, in the disclosure, an error due to the backlash of a ball screw is assumed as the positioning error of the machine tool 1. Accordingly, usually, the positioning error on the + side and the positioning error on the − side have a relationship in which the signs are inverted. Therefore, when the absolute value of the positioning error on the + side and the absolute value of the positioning error on the − side are considered to be the same based on the characteristics of the machine tool 1 used, the first terms on the right sides of the formulas (10) and (13) become 0. At this time, the right sides of the formulas (10) and (13) correspond to the right sides of the formulas (4) and (5). In the other words, in second method, when the absolute value of the positioning error on the + side and the absolute value of the positioning error on the − side are considered to be the same, the formula expressed as the sum of the diameter compensation value of the touch trigger probe 8 when measuring the + side face and the diameter compensation value of the touch trigger probe 8 when measuring the − side face being divided by two is the same as the formula to calculate the initial value 16 of the offset displacement amount in the first method. Consequently, the method for obtaining the diameter compensation value of the touch trigger probe 8 using a calibration reference becomes the second method to calculate the initial value 16 of the offset displacement amount. That is, by using the second method, the initial value 16 of the offset displacement amount can be easily calculated from the diameter compensation value of the touch trigger probe 8.

Note that, in both the first method and the second method, the initial value 16 of the offset displacement amount calculated is stored in the initial offset value estimating unit 11.

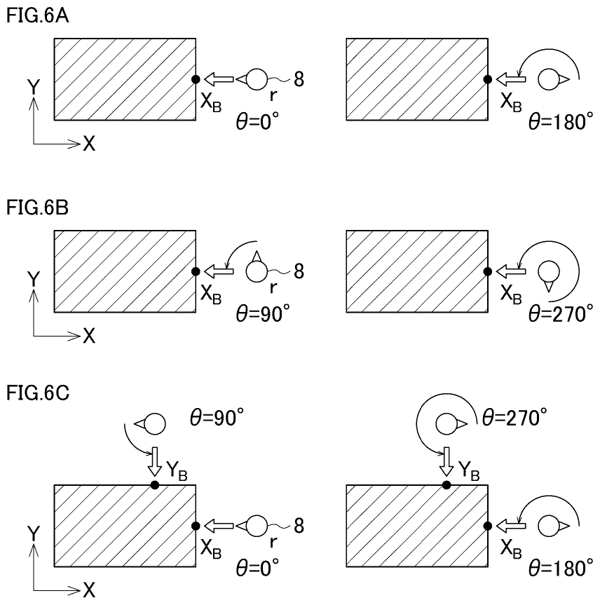

Next, a method to calculate the value 17 of the offset-displacement-amount-during-inspection by the offset value-during-inspection estimating unit 13 is described based on FIGS. 6A to 6C. The method illustrated in FIGS. 6A to 6C is the same as the first method to calculate the initial value 16 of the offset displacement amount described using FIGS. 4A to 4C. FIGS. 6A to 6C are explanatory views of a measurement object during inspection and the stylus ball of the touch trigger probe 8 viewed from the top when the value 17 of the offset-displacement-amount-during-inspection is calculated. In FIGS. 6A to 6C, a hatched part, a black circle, and a small circle represent the measurement object during inspection, a measurement point, and the stylus ball having a radius r, respectively. In addition, a white triangle attached to the stylus ball represents the indexing direction of the main spindle 7 to which the touch trigger probe 8 is mounted. Further, a white arrow represents the contact direction in which the stylus ball, namely, touch trigger probe is brought into contact with the measurement object during inspection. Furthermore, an angle between the indexing direction and the contact direction is defined as a measurement angle θ.

The measurement to calculate the value 17 of the offset-displacement-amount-during-inspection is performed at the same reference measurement angle as when the initial value 16 of the offset displacement amount has been calculated. Accordingly, for example, when the measurements as illustrated in FIGS. 4A and 4B have been performed to calculate the initial values 16 of the offset displacement amount, a measurement to measure a measurement point X_{B} is performed by setting the first reference measurement angle to 0° as illustrated in FIG. 6A and the second reference measurement angle to 90° as illustrated in FIG. 6B.

First, as illustrated in FIG. 6A, the first reference measurement angle is set to 0°, and the measurement point X_{B} on a measurement surface of the measurement object during inspection is measured at 0° and 180°. At this time, an inspection-measurement-result-before-inversion, which is the measurement result at 0°, can be expressed by the following formula (14). Further, an inspection-measurement-result-after-inversion, which is the measurement result at 180°, can be expressed by the following formula (15). As evident from the formulas (14) and (15), the measurement results A₁, A₁′ are those in which the diameter compensation value Cₓ₊ when measuring the X₊ side face, which is the diameter compensation value of the touch trigger probe 8, is subtracted from actual measurement values.

$${A}_{1} = {x}_{B} + r + {E}_{m , x +} + {E}_{p , θ = 0} + {E}_{s , θ = 0} - {C}_{x +} \qquad Formula ( 14 )$$

$${A}_{1} = {x}_{B} + ( {E}_{m , x +} - {\hat{E}}_{m , x +} ) + ( {E}_{p , θ = 0} - {\hat{E}}_{p , θ = 0} ) + ( {d}_{s} cos {θ}_{s} - {\hat{d}}_{s} cos {\hat{θ}}_{s} )$$

$${{A}_{1}}^{′} = {x}_{B} + r + {E}_{m , x +} + {E}_{p , θ = 180} + {E}_{s , θ = 180} - {C}_{x +} \qquad Formula ( 15 )$$

$${{A}_{1}}^{′} = {x}_{B} + ( {E}_{m , x +} - {\hat{E}}_{m , x +} ) + ( {E}_{p , θ = 180} - {\hat{E}}_{p , θ = 0} ) + ( - {d}_{s} cos {θ}_{s} - {\hat{d}}_{s} cos {\hat{θ}}_{s} )$$

A₁: Inspection-measurement-result-before-inversion with respect to the first reference measurement angle
A₁′: Inspection-measurement-result-after-inversion with respect to the first reference measurement angle
X_{B}: True X-coordinate of the measurement point X_{B} in the inspection measurement
E_{m,x+}: Current value of the positioning error on the X-axis + side of the machine tool
E_{p,θ}: Current value of the error caused by the characteristic of the touch trigger probe
E_{s,θ}: Current value of the error caused by stylus bending
θₛ: Current value of the angle of the stylus ball center position with respect to the main spindle center
dₛ: Current value of the distance to the stylus ball center position with respect to the main spindle center

Here, the change in the positioning error Eₘ of the machine tool 1 and the change in the error Eₚ caused by the signal output characteristic of the touch trigger probe 8 are small as described above. In this case, the formulas (14) and (15) can be approximated as formulas (16) and (17) described below.

$${A}_{1} ≅ {x}_{B} + ( {d}_{s} cos {θ}_{s} - {\hat{d}}_{s} cos {\hat{θ}}_{s} ) \qquad Formula ( 16 )$$

$${{A}_{1}}^{′} ≅ {x}_{B} + ( - {d}_{s} cos {θ}_{s} - {\hat{d}}_{s} cos {\hat{θ}}_{s} ) \qquad Formula ( 17 )$$

In the formulas (16) and (17), while the true coordinate value X_{B} of the measurement point X_{B} is an unknown number. However, as evident from the formulas (16) and (17), the influence based on the true coordinate value X_{B} of the measurement point X_{B} is unknown number can be canceled by taking the difference between the inspection-measurement-result-before-inversion A₁ with respect to the first reference measurement angle and the inspection-measurement-result-after-inversion A₁′ with respect to the first reference measurement angle. Accordingly, the value 17 (E₁) of the offset-displacement-amount-during-inspection in the X-axis direction (at the first reference measurement angle) is calculated according to the following formula (18).

$${E}_{1} = \frac{{A}_{1} - {{A}_{1}}^{′}}{2} ≅ \frac{{\hat{E}}_{p , θ = 0} - {\hat{E}}_{p , θ = 180}}{2} + {d}_{s} cos {θ}_{s} \qquad Formula ( 18 )$$

E₁: Value of the offset-displacement-amount-during-inspection with respect to the first reference measurement angle

On the other hand, when the same calculations as in the X-axis direction are performed in the Y-axis direction, the value 17 (E₂) of the offset-displacement-amount-during-inspection in the Y-axis direction (at the second reference measurement angle) is calculated according to the following formula (19).

$${E}_{2} = \frac{{A}_{2} - {{A}_{2}}^{′}}{2} ≅ \frac{{\hat{E}}_{p , θ = 90} - {\hat{E}}_{p , θ = 270}}{2} - {d}_{s} sin {θ}_{s} \qquad Formula ( 19 )$$

A₂: Inspection-measurement-result-before-inversion with respect to the second reference measurement angle
A₂′: Inspection-measurement-result-after-inversion with respect to the second reference measurement angle
E₂: Value of the offset-displacement-amount-during-inspection with respect to the second reference measurement angle

As described above, a predetermined measurement point of the measurement object during inspection is measured at two measurement angles, which are the reference measurement angle and a measurement angle inverted 180° with respect to the reference measurement angle. Then, the measurement error component can be extracted by taking the difference between the inspection-measurement-result-before-inversion A₁, A₂ and the inspection-measurement-result-after-inversion A₁′, A₂′.

Finally, in the compensation value error estimating unit 14, an error of the compensation value in the radial direction of the touch trigger probe 8, namely, the compensation value error estimation amount 18 is calculated. In order to calculate the compensation value error estimation amount 18, as expressed by the following formulas (20) and (21), the difference between the initial values 16 (Ê₁, Ê₂) of the offset displacement amount, which is obtained according to the formulas (4) and (5), and the values 17 (E₁, E₂) of the offset-displacement-amount-during-inspection, which is obtained according to the formulas (18) and (19), is taken.

$$Δ {E}_{1} = {E}_{1} - {\hat{E}}_{1} ≅ {d}_{s} cos {θ}_{s} - {\hat{d}}_{s} cos {\hat{θ}}_{s} \qquad Formula ( 20 )$$

$$Δ {E}_{2} = {E}_{2} - {\hat{E}}_{2} ≅ - ( {d}_{s} sin {θ}_{s} - {\hat{d}}_{s} sin {\hat{θ}}_{s} ) \qquad Formula ( 21 )$$

ΔE₁: Error of the compensation value in the radial direction in the first reference measurement angle direction
ΔE₂: Error of the compensation value in the radial direction in the second reference measurement angle direction

Here, the error of the compensation values ΔE₁ and ΔE₂ in the radial direction of the touch trigger probe 8 obtained according to the formulas (20) and (21) are described.

In the formula (16), the inspection-measurement-result-before-inversion with respect to the first reference measurement angle A₁, is the result of measuring the measurement point X_{B} at the first reference measurement angle. Therefore, in the formula (16), the measurement error with respect to the true coordinate value X_{B} of the measurement point X_{B} is (dₛ cos θₛ−\hat{d}ₛ cos \hat{θ}ₛ). The measurement error is an error related to a deviation that is generated between the offset displacement amount of the touch trigger probe 8 when the compensation value in the radial direction is set and the offset displacement amount of the touch trigger probe 8 when the measurement is performed since the offset displacement amount of the touch trigger probe 8 changes over time. Further, the measurement error corresponds to the right side of the formula (20). In addition, when the same calculation as in the first reference measurement angle direction is performed in the second reference measurement angle direction, the measurement error is (−dₛ sin θₛ+\hat{d}ₛ sin θₛ) with respect to the true coordinate value X_{B} of the measurement point X_{B} is calculated, and the measurement error corresponds to the right side of the formula (21). Therefore, by using the method of the disclosure, it is possible to estimate the compensation value error estimation amount 18, namely, the error of the compensation value in the radial direction of the touch trigger probe 8 in a predetermined measurement angle direction.

In the embodiment described above, the offset displacement amounts with respect to the first reference measurement angle and the second reference measurement angle are calculated by the measurement of the same measurement point in the X-axis direction while the indexing angle of the main spindle 7 is changed. However, in both the measurement by the initial offset value estimating unit 11 and the measurement by the offset value-during-inspection estimating unit 13, a measurement point and a measurement direction may be different between the measurement with respect to the first reference measurement angle and the measurement with respect to the second reference measurement angle. For example, as illustrated in FIG. 4C and FIG. 6C, the measurement may be performed in the X-axis direction at the time of the measurement at 0°, which is the first reference measurement angle, whereas the measurement may be performed in the Y-axis direction at the time of the measurement at 90°, which is the second reference measurement angle. In this case, according to the measurement is performed at the measurement angle of 0° in the X-axis direction, the measurement result before inversion with respect to the first reference measurement angle is obtained. Also, according to the measurement is performed at the measurement angle of 90° in the Y-axis direction while the indexing direction of the main spindle 7 unchanged, the measurement result before inversion with respect to the second reference measurement angle is obtained. Next, after the indexing direction of the main spindle 7 is inverted, the measurement is performed at the measurement angle of 180° in the X-axis direction to obtain the measurement result after inversion with respect to the first reference measurement angle. Also, according to the measurement is performed at the measurement angle of 270° in the Y-axis direction while the indexing direction of the main spindle 7 unchanged, the measurement result after inversion with respect to the second reference measurement angle is obtained. Thus, as long as the first reference measurement angle is perpendicular to the second reference measurement angle, even if the measurement point and the measurement direction are different, the same initial values 16 of the offset displacement amount as those according to the formulas (4) and (5), or the same values 17 of the offset-displacement-amount-during-inspection as those according to the formulas (18) and (19) can be obtained.

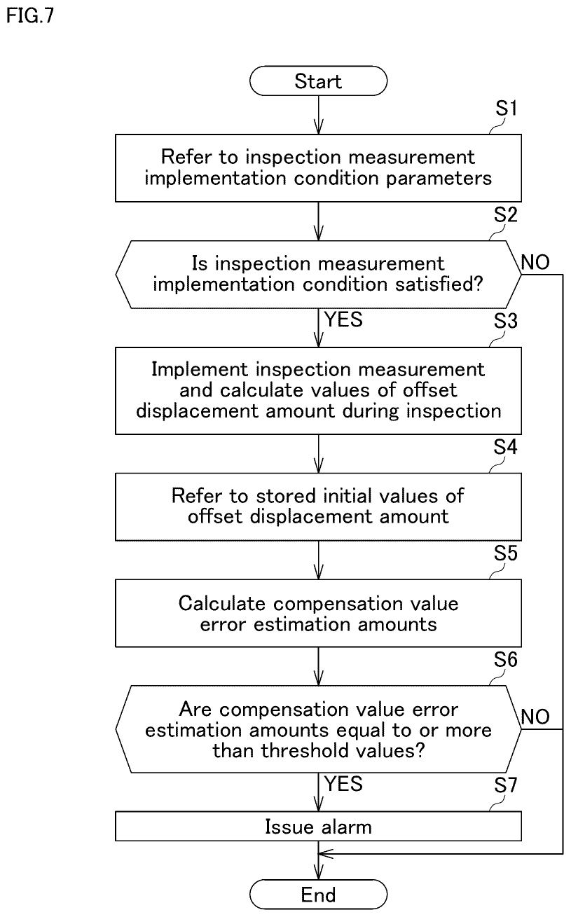

In addition, the process flow related to the inspection of the compensation value of the touch trigger probe 8 by the compensation value inspection system for the touch trigger probe 8 of the embodiment is described using the flowchart in FIG. 7. The inspection of the compensation value of the touch trigger probe 8 is an inspection of whether or not calibration work is necessary to reset the compensation value of the touch trigger probe 8, and it can be said that it is an inspection of the measurement accuracy with the touch trigger probe 8.
S1: Refer to inspection measurement implementation condition parameters. As the inspection measurement implementation condition parameters, it is only necessary to employ, for example, the temperature information of at least one of the machine tool and the surrounding area, the elapsed time since the previous inspection measurement and the count value of the number of measurements using the touch trigger probe. Depending on the parameters to be employed, for example, systems to measure and store information, such as temperature values, elapsed time and the number of measurements, and temperature sensors are incorporated in advance in the machine tool 1 and the NC unit 10.
S2: Determine whether or not an inspection measurement implementation condition is satisfied. Specifically, threshold values are set in advance for the inspection measurement implementation condition parameters referred to in S1. Then, when the inspection measurement implementation condition parameters exceed the threshold values, it is determined that the inspection measurement implementation condition is satisfied. As the threshold values, for example, it is conceivable that the change in the ambient temperature of the machine tool from the previous calibration is 5° C. or more, or that the elapsed time since the previous inspection measurement is 2 hours or more. Note that, for the above inspection measurement implementation condition parameters and the threshold values, a setting screen may be disposed in the NC unit 10 such that an operator can set them conveniently.

The processing of S1 and S2 described above is performed by the inspection measurement implementation determining unit 12 disposed in the NC unit 10.
S3: Implement an inspection measurement upon determining that the inspection measurement condition is satisfied in S2 and calculate the values 17 of the offset-displacement-amount-during-inspection. The values 17 of the offset-displacement-amount-during-inspection are measured by the method illustrated in FIGS. 6A to 6C and calculated according to the formulas (14) to (19), as described above.
S4: Refer to the initial values 16 of the offset displacement amount stored in advance in the initial offset value estimating unit 11. The initial values 16 of the offset displacement amount are measured by the method illustrated in FIGS. 4A to 4C and FIG. 5 and calculated according to the formulas (4) and (5) or the formulas (10) and (13), as described above.
S5: Calculate the compensation value error estimation amounts 18, which are the amounts of change in measurement error, based on the initial values 16 of the offset displacement amount and the values 17 of the offset-displacement-amount-during-inspection. The compensation value error estimation amounts 18 are calculated according to the formulas (20) and (21) as described above.
S6: Compare the compensation value error estimation amounts 18 calculated in S5 with threshold values in the compensation value error displaying unit 15. At this time, the compensation value error estimation amounts 18 in the X-axis direction and the Y-axis direction are compared with the corresponding threshold values. Note that, the threshold values are preset in the compensation value error displaying unit 15. A setting screen for the threshold values may be disposed in the NC unit 10 such that an operator can set them conveniently.
S7: Execute a warning action in the compensation value error displaying unit 15 when the compensation value error estimation amounts 18 exceed the threshold values. Specifically, an alarm is issued, and an indication that an alarm has been issued is displayed. As the method for issuing an alarm, for example, a warning lamp and a buzzer may be installed in the machine tool 1 and activate them. In addition, the program of the machine tool 1 may be stopped along with the execution of the warning action such that the measurement with the touch trigger probe 8 is not performed while the compensation value error estimation amounts 18 exceed the threshold values.

In the above described processing of S6 and S7 performed by the compensation value error displaying unit 15, for example, the compensation value error estimation amounts 18 calculated in S5 may be displayed on a screen such that an operator can view and determine whether or not to calibrate the touch trigger probe 8. Moreover, it can be configured to store the compensation value error estimation amounts 18 calculated from past inspection measurements and the transition thereof may be displayed as a graph.

With the compensation value inspection system and the compensation value inspection method for the touch trigger probe 8 having the configuration described above, the initial values 16 of the offset displacement amount, which are deviations of the center position of the stylus ball of the touch trigger probe 8 with respect to the center of the main spindle 7, are calculated based on the initial-measurement-results-before-inversion and the initial-measurement-results-after-inversion. The initial-measurement-results-before-inversion are obtained by measurements of an initial measurement object at the first reference measurement angle and the second reference measurement angle, with a predetermined measurement angle set as the first reference measurement angle and a measurement angle perpendicular to the first reference measurement angle set as the second reference measurement angle. The initial-measurement-results-after-inversion are obtained by measurement of the initial measurement object at a measurement angle varied by 180° from the first reference measurement angle and a measurement angle varied by 180° from the second reference measurement angle. In addition, the values 17 of the offset-displacement-amount-during-inspection are calculated based on the inspection-measurement-results-before-inversion and the inspection-measurement-results-after-inversion. The inspection-measurement-results-before-inversion are obtained by measurements of a measurement object during inspection at the first reference measurement angle and the second reference measurement angle. The inspection-measurement-results-after-inversion are obtained by measurements of the measurement object during inspection at the measurement angle varied by 180° from the first reference measurement angle and the measurement angle varied by 180° from the second reference measurement angle. Furthermore, the compensation value error estimation amounts 18, which are errors of the compensation values of the touch trigger probe 8, are calculated based on the initial values 16 of the offset displacement amount and the values 17 of the offset-displacement-amount-during-inspection. Therefore, calibration of the touch trigger probe 8 can be implemented only when necessary according to the calculated compensation value error estimation amounts 18, and the implementation frequency of calibration work of the touch trigger probe 8 can be minimized without impairing accuracy. Moreover, it is not required to set up a calibration reference, such as the reference ball 9, at every inspection. Also, for example, the number of inversions of the main spindle 7 are required less. Therefore, the work period for the calibration work can be shortened.

Note that, the compensation value inspection system and the compensation value inspection method for the touch trigger probe according to the disclosure are not limited to the aspects of the above-described embodiments and can be appropriately changed as necessary without departing from the spirit of the disclosure.

For example, in the above embodiments, the compensation value inspection system is applied to a three-axis machining center, but the disclosure is applicable to other types of machine tools. For example, the machine tool may be a lathe, multitasking machine and grinder instead of a machining center. Furthermore, the number of axes is not limited to three axes. Thus, for example, the machine rotatably and pivotally supporting a table, and the main spindle head rotating around the axis in the front-rear direction do not cause any problems.

In addition, although a reference ball is used in the above embodiments, a cylindrical reference that can measure an outer circumferential surface and a ring gauge that can measure an inner circumferential surface may be used as a calibration reference.

Furthermore, the measurement point to be measured with the touch trigger probe when the value of the offset-displacement-amount-during-inspection is calculated may be the same as or different from the measurement point to be measured when the initial value of the offset displacement amount is calculated.

Moreover, the measurement object during inspection used when the value of the offset-displacement-amount-during-inspection is calculated may be the same as or different from the initial measurement object used when the initial value of the offset displacement amount is calculated. In the above embodiment, the side face of the table is taken as an example of the initial measurement object and the measurement object during inspection, but the initial measurement object and the measurement object during inspection may be a portion of the machine tool other than the table, or a jig or a workpiece installed on the table. However, it is necessary to perform the measurement when the value of the offset-displacement-amount-during-inspection is calculated and the measurement when the initial value of the offset displacement amount is calculated at the same measurement angle.

Furthermore, in the above embodiments, as the inspection measurement implementation condition parameters, the temperature information of at least one of the machine tool and the surrounding area, the elapsed time since the previous inspection measurement, and the count value of the number of touch trigger probe measurements are presented. However, for example, an amount of movement of the feed axis, a number of inversions of the feed axis, a cutting distance and a number of workpieces to be machined may be employed. Note that, the amount of movement of the feed axis can be rephrased as, for example, the movement distance of a workpiece. In addition, the cutting distance is the amount of movement of the feed axis during the machining of a workpiece.

In addition, in the above embodiments, the first reference measurement angle is set to 0°, and the second reference measurement angle is set to 90°. However, as long as both reference measurement angles are perpendicular to one another, the first reference measurement angle and the second reference measurement angle can be set freely. Further, if the angle required for the inspection is only one predetermined direction, only one reference measurement angle is required. For example, if the angle required for the inspection is only in the X-axis direction, the initial value of the offset displacement amount and the value of the offset-displacement-amount-during-inspection may be configured to calculate only at 0°.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

1. A compensation value of a touch trigger probe inspection system that inspects an error of a compensation value of a touch trigger probe mounted to a main spindle in a machine tool, the machine tool having translational axes of three or more axes and the main spindle rotatable with a tool mounted thereon, wherein
an angle between an indexing direction of the main spindle to which the touch trigger probe is mounted and a contact direction is set as a measurement angle, the contact direction is a direction in which the touch trigger probe is brought into contact with a predetermined measurement object by movement of the main spindle on a plane perpendicular to an axis line of the main spindle,
the measurement object is measurable with the touch trigger probe at a plurality of the measurement angles,
a predetermined measurement angle is set as a first reference measurement angle, and
the compensation value of the touch trigger probe inspection system comprises:
an initial offset value estimating unit that calculates an initial value of an offset displacement amount as a deviation of a center position of a stylus ball of the touch trigger probe with respect to a center of the main spindle, based on an initial-measurement-result-before-inversion and an initial-measurement-result-after-inversion, the initial-measurement-result-before-inversion being obtained by measuring an initial measurement object at the first reference measurement angle, the initial-measurement-result-after-inversion being obtained by measuring the initial measurement object at a measurement angle varied by 180° from the first reference measurement angle;
an offset value during inspection estimating unit that calculates a value of the offset-displacement-amount-during-inspection based on an inspection-measurement-result-before-inversion and an inspection-measurement-result-after-inversion, the inspection-measurement-result-before-inversion being obtained by measuring a measurement object during inspection at the first reference measurement angle, the inspection-measurement-result-after-inversion being obtained by measuring the measurement object during inspection at the measurement angle varied by 180° from the first reference measurement angle; and
a compensation value error estimating unit that estimates an error of a compensation value of the touch trigger probe based on the initial value of the offset displacement amount and the value of the offset-displacement-amount-during-inspection.

2. The compensation value of a touch trigger probe inspection system according to claim 1, wherein
the initial offset value estimating unit obtains the initial-measurement-result-after-inversion by varying the indexing direction of the main spindle by 180° while the contact direction for obtaining the initial-measurement-result-before-inversion unchanged.

3. The compensation value of a touch trigger probe inspection system according to claim 1, wherein
the initial measurement object is a ring-shaped, spherical, or cylindrical calibration reference, and
the initial offset value estimating unit obtains the initial-measurement-result-after-inversion by varying the contact direction by 180° while the indexing direction of the main spindle for obtaining the initial-measurement-result-before-inversion unchanged.

4. The compensation value of a touch trigger probe inspection system according to claim 1, wherein
a measurement angle perpendicular to the first reference measurement angle is set as a second reference measurement angle,
the initial offset value estimating unit calculates an initial value of the offset displacement amount with respect to the second reference measurement angle based on a measurement result at the second reference measurement angle and a measurement result at a measurement angle varied by 180° from the second reference measurement angle, and
the offset value-during-inspection estimating unit calculates the value of the offset-displacement-amount-during-inspection based on a measurement result at the second reference measurement angle and a measurement result at the measurement angle varied by 180° from the second reference measurement angle.

5. A compensation value inspection method for inspecting an error of a compensation value of a touch trigger probe in a machine tool, the machine tool having translational axes of three or more axes and a main spindle rotatable with a tool mounted thereon,
wherein an angle between an indexing direction of the main spindle to which the touch trigger probe is mounted and a contact direction is set as a measurement angle, the contact direction is a direction in which the touch trigger probe is brought into contact with a predetermined measurement object by movement of the main spindle on a plane perpendicular to an axis line of the main spindle,
the measurement object is measurable with the touch trigger probe at a plurality of the measurement angles,
a predetermined measurement angle is set as a first reference measurement angle, and
the compensation value inspection method comprising:
calculating an initial value of an offset displacement amount as a deviation of a center position of a stylus ball of the touch trigger probe with respect to a center of the main spindle, based on an initial-measurement-result-before-inversion and an initial-measurement-result-after-inversion, the initial-measurement-result-before-inversion being obtained by measuring an initial measurement object at a first reference measurement angle, the initial-measurement-result-after-inversion being obtained by measuring the initial measurement object at a measurement angle varied by 180° from the first reference measurement angle;
calculating a value of the offset-displacement-amount-during-inspection based on an inspection-measurement-result-before-inversion and an inspection-measurement-result-after-inversion, the inspection-measurement-result-before-inversion being obtained by measuring a measurement object during inspection at the first reference measurement angle, the inspection-measurement-result-after-inversion being obtained by measuring the measurement object during inspection at the measurement angle varied by 180° from the first reference measurement angle; and
estimating an error of a compensation value of the touch trigger probe based on the initial value of the offset displacement amount and the value of the offset-displacement-amount-during-inspection.
